(19) United States
(12) Patent Application Publication
(10) Pub. No.: US 2025/0015342 A1
(43) Pub. Date: Jan. 9, 2025

(54) ALL-SOLID-STATE BATTERY INCLUDING METAL OXIDE AND METAL CAPABLE OF ALLOYING WITH LITHIUM AND A METHOD OF MANUFACTURING THE SAME

(71) Applicants: HYUNDAI MOTOR COMPANY, Seoul (KR); KIA CORPORATION, Seoul (KR); Seoul National University R&DB Foundation, Seoul (KR)

(72) Inventors: Ji Young Kim, Suwon-si (KR); Kyu Joon Lee, Seoul (KR); Ga Hyeon Im, Hwaseong-si (KR); Ki Yoon Bae, Seoul (KR); Yun Sung Kim, Seoul (KR); Sam Ick Son, Suwon-si (KR); Jang Wook Choi, Seoul (KR); Ji Eun Lee, Seongnam-si (KR); Ye Eun Sohn, Seoul (KR); Ji Hoon Oh, Seoul (KR); Tae Guen Lee, Ansan-si (KR); Noh Joon Lee, Seoul (KR)

(73) Assignees: HYUNDAI MOTOR COMPANY, Seoul (KR); KIA CORPORATION, Seoul (KR); Seoul National University R&DB Foundation, Seoul (KR)

(21) Appl. No.: 18/530,991

(22) Filed: Dec. 6, 2023

(30) Foreign Application Priority Data
Jul. 6, 2023 (KR) 10-2023-0087516

(51) Int. Cl. H01M 10/0562; H01M 10/0525; H01M 10/0585

(52) U.S. Cl. CPC H01M 10/0562; H01M 10/0525; H01M 10/0585; H01M 2300/0068

(57) ABSTRACT

An all-solid-state battery and a method of manufacturing an all solid-state battery are disclosed. The all solid-state battery includes a metal oxide and a metal capable of alloying with lithium, thus uniformly depositing lithium during charging and enabling operation at room temperature (e.g., 20-25° C.).

### CROSS-REFERENCE TO RELATED APPLICATION

This application claims, under 35 U.S.C. § 119 (a), the benefit of and priority to Korean Patent Application No. 10-2023-0087516, filed on Jul. 6, 2023, the entire contents of which are incorporated herein by reference.

### BACKGROUND

### (a) Technical Field

The present disclosure relates to an all-solid-state battery including a metal oxide and a metal capable of alloying with lithium, thus uniformly depositing lithium during charging and enabling operation at room temperature and a method of manufacturing the same.

### (b) Background Art

An all-solid-state battery is configured to include a three-layered laminate with a cathode layer bonded to a cathode current collector, an anode active material layer bonded to an anode current collector, and a solid electrolyte layer disposed between the cathode layer and the anode active material layer.

The anode active material layer of an all-solid-state battery may be formed by mixing the anode active material with a solid electrolyte for attaining ionic conductivity. Since the solid electrolyte has higher specific gravity than a liquid electrolyte, the energy density of the conventional all-solid-state battery is lower than that of a lithium ion battery. In this regard, research into applying lithium metal as an anode has been conducted to increase the energy density of an all-solid-state battery, but there are problems such as interfacial bonding, growth of lithium dendrites, price, difficulty in large-area formation, etc.

Recently, research is ongoing into a storage-type anode-less all-solid-state battery in which the anode of the all-solid-state battery is removed, and lithium is directly deposited on the anode current collector. However, the battery described above is problematic in that lifespan and durability are very poor due to irreversible reaction gradually increasing owing to non-uniform precipitation of lithium. In order to solve this problem, attempts have been made to coat the anode current collector with a metal powder, but this yielded unsatisfactory results, such as a phenomenon in which metal and lithium are not uniformly deposited during charging, etc.

The statements in this section merely provide background information related to the present disclosure and may not constitute prior art.

### SUMMARY

The present disclosure has been made keeping in mind the problems encountered in the related art, and an object of the present disclosure is to provide an all-solid-state battery including a metal oxide and a metal capable of alloying with lithium, thus uniformly depositing lithium during charging and enabling operation at room temperature (e.g., 20-25° C.).

Another object of the present disclosure is to provide a method of manufacturing the all-solid-state battery including the metal oxide and the metal.

The objects of the present disclosure are not limited to the foregoing. The objects of the present disclosure are able to be clearly understood through the following description and realized by the means described in the claims and combinations thereof.

An embodiment of the present disclosure provides an all-solid-state battery that includes an anode current collector, a protective layer disposed on the anode current collector, a solid electrolyte layer disposed on the protective layer, wherein the protective layer is positioned between the anode current collector and the solid electrolyte layer; a cathode layer disposed on the solid electrolyte layer and comprising a cathode active material, wherein the solid electrolyte layer is positioned between the protective layer and the cathode layer; and a cathode current collector disposed on the cathode layer, wherein the cathode layer is positioned between the solid electrolyte layer and the cathode current collector.

The protective layer may include a metal and a metal oxide, and the metal and the metal oxide are capable of alloying with lithium.

The metal may include silver (Ag), magnesium (Mg), zinc (Zn), gold (Au), or a combination thereof.

The metal oxide may include zinc (Zn) oxide, tin (Sn) oxide, silicon (Si) oxide, germanium (Ge) oxide, indium (In) oxide, antimony (Sb) oxide, bismuth (Bi) oxide, gallium (Ga) oxide, aluminum (AI) oxide, titanium (Ti) oxide, zirconium (Zr) oxide, nickel (Ni) oxide, iron (Fe) oxide, cobalt (Co) oxide, chromium (Cr) oxide, magnesium (Mg) oxide, or a combination thereof.

The mass ratio of the metal oxide to the metal in the protective layer may be in a range of 3:7 to 7:3.

The metal oxide may form an alloy with lithium in a higher voltage range than the metal.

The metal oxide may form an alloy with lithium at a voltage in a range of 0.4 V to 0.7 V and the metal may form an alloy with lithium at a voltage in a range of 0.1 V to 0.3 V.

The lithium ion diffusivity coefficient (D) of the protective layer may be in a range of 1.2 to 2.3 m²/s.

The metal oxide and the metal may have particle sizes (D₅₀) in a range of 0.1 μm to 1 μm.

The thickness of the protective layer may be in a range of 1 to 20 μm.

Another embodiment of the present disclosure provides a method of manufacturing an all-solid-state battery, including preparing a slurry by mixing a metal oxide, a metal, a conductive material, and a binder, forming a protective layer by applying the slurry onto an anode current collector, forming a solid electrolyte layer on the protective layer, forming a cathode layer on the solid electrolyte layer, and forming a cathode current collector on the cathode layer.

### BRIEF DESCRIPTION OF THE DRAWINGS

The above and other features of the present disclosure are now described in detail with reference to certain exemplary embodiments thereof illustrated in the accompanying drawings, which are given hereinbelow by way of illustration only, and thus are not limitative of the present disclosure, and wherein:

FIG. 1 shows an example of a cross-sectional view of an all-solid-state battery;

FIG. 2 shows an example of a metal oxide and a metal alloying with lithium ions;

FIG. 3 shows an example of a scanning electron microscope (SEM) image of a top view of a protective layer when a half cell is charged;

FIG. 4 shows an example of an SEM image of a cross-sectional view of the half-cell that is charged;

FIG. 5 shows a 1^{st} discharge graph of a half-cell according to Test Example;

FIG. 6 shows a 60^{th} discharge graph of the half-cell according to Test Example;

FIG. 7 is a graph showing results of evaluating the lifespan of the half-cell according to Test Example;

FIG. 8 shows operation of a half-cell according to Comparative Example 1;

FIG. 9 shows operation of a half-cell according to Comparative Example 2;

FIG. 10 is a graph showing results of evaluating the lifespan of a full cell according to Test Example;

FIG. 11 shows 1^{st} and 100^{th} discharge graphs of the full cell according to Test Example;

FIG. 12 is a graph showing alloying of a metal oxide and a metal with lithium ions in different voltage ranges according to Test Example;

FIG. 13 schematically shows an example of a half-cell potential graph during a GITT (galvanostatic intermittent titration technique) pulse;

FIG. 14 shows results of analyzing an XRD pattern of the full cell according to Test Example;

FIG. 15 shows an example of SEM images of a cross-section of the full cell during charging and discharging;

FIGS. 16A to 16C show examples of images of oxygen (O) distribution in the vicinity of the protective layer during charging and discharging of the full cell; and

FIGS. 17A to 17C show examples of images of zinc (Zn) distribution in the vicinity of the protective layer during charging and discharging of the full cell.

### DETAILED DESCRIPTION

The above and other objects, features, and advantages of the present disclosure are more clearly understood from the following embodiments taken in conjunction with the accompanying drawings. However, the present disclosure is not limited to the embodiments disclosed herein and may be modified into different forms. These embodiments are provided to thoroughly explain the disclosure and to sufficiently transfer the spirit of the present disclosure to those skilled in the art.

Throughout the drawings, the same reference numerals refer to the same or like elements. For the sake of clarity of the present disclosure, the dimensions of structures are depicted as being larger than the actual sizes thereof. Although terms such as “first,” “second,” etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

Terms “comprise,” “include,” “have,” etc., when used in this specification, specify the presence of stated features, integers, steps, operations, elements, components, or combinations thereof, but do not preclude the presence or addition of one or more other features, integers, steps, operations, elements, components, or combinations thereof. Also, when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

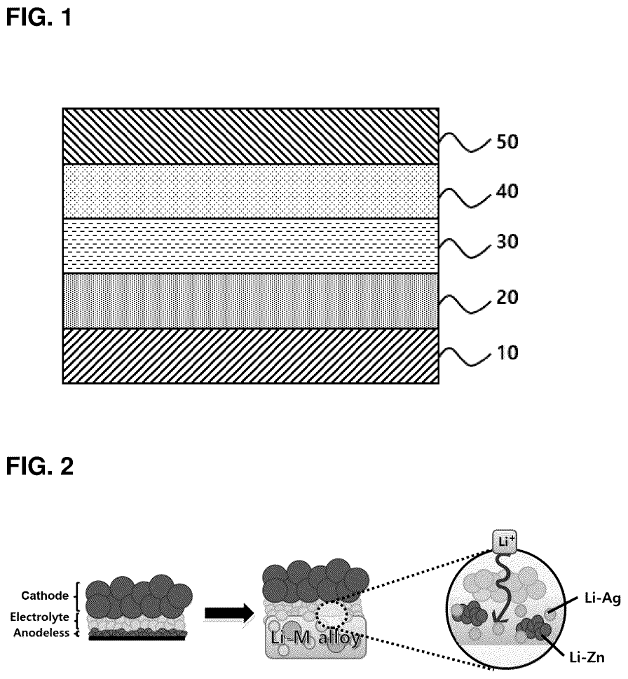

FIG. 1 is a cross-sectional view showing an all-solid-state battery. With reference thereto, the all-solid-state battery may be configured such that an anode current collector 10, a protective layer 20, a solid electrolyte layer 30, a cathode layer 40, and a cathode current collector 50 are sequentially stacked.

The all-solid-state battery may be an anode-less all-solid-state battery in which a lithium storage layer including lithium metal, a lithium alloy, and lithium oxide (Li₂O) is formed between the solid electrolyte layer and the anode current collector during charging.

The anode current collector 10 may be a plate-shaped substrate having electrical conductivity. The anode current collector 10 may include nickel (Ni), stainless steel (SUS), or a combination thereof.

The anode current collector 10 may be a high-density metal thin film having a porosity of less than 1%.

The anode current collector 10 may have a thickness in a range of 1 μm to 20 μm or in a range of 5 μm to 15 μm.

The protective layer 20 allows lithium ions (Li+) moved from the cathode layer 40 to be uniformly deposited between the solid electrolyte layer 30 and the anode current collector 10 during charging of the all-solid-state battery. Also, the protective layer 20 prevents internal short circuit from occurring due to growth of lithium dendrites. A detailed description thereof is provided in greater detail below.

The protective layer 20 may include a metal and a metal oxide. The metal and the metal oxide may individually form an alloy with lithium.

The metal may include silver (Ag), magnesium (Mg), zinc (Zn), gold (Au), or a combination thereof.

The metal oxide may include zinc (Zn) oxide, tin (Sn) oxide, silicon (Si) oxide, germanium (Ge) oxide, indium (In) oxide, antimony (Sb) oxide, bismuth (Bi) oxide, gallium (Ga) oxide, aluminum (AI) oxide, titanium (Ti) oxide, zirconium (Zr) oxide, nickel (Ni) oxide, iron (Fe) oxide, cobalt (Co) oxide, chromium (Cr) oxide, magnesium (Mg) oxide, or a combination thereof.

In certain examples, the metal oxide includes zinc oxide (ZnO).

Lithium ions moved from the cathode layer 40 are allowed to flow into the protective layer 20 shown in FIG. 1 through the solid electrolyte layer 30. When the metal oxide included in the protective layer 20 is zinc oxide, the metal oxide undergoes electrochemical reaction with lithium ions as shown in Schemes 1 and 2 below.

2ZnO+4Li⁺→2Zn⁺+2Li₂O (Scheme 1)

Zn+Li⁺→Zn—Li (Alloy) (Scheme 2)

Specifically, the metal oxide and lithium ions react according to Scheme 1 to produce lithium oxide (Li₂O) and zinc (Zn), and zinc (Zn) reacts with other lithium ions to form a lithium-zinc alloy (Zn—Li).

In addition, lithium ions moved from the cathode layer 40 to the protective layer 20 undergo electrochemical reaction with the metal as shown in Scheme 3 below.

Ag+Li⁺→Ag—Li (Alloy) (Scheme (3)

Specifically, the metal and lithium ions react according to Scheme 3 to form a lithium-silver alloy (Ag—Li).

Formation of the lithium-zinc alloy (Zn—Li) and the lithium-silver alloy (Ag—Li) is shown in FIG. 2.

The lithium alloy not only stores lithium ions but also serves as a kind of seed so that lithium ions may be deposited as lithium metal.

Here, lithium oxide (Li₂O) inhibits the growth of lithium dendrites and prevents aggregation of metal oxides. Specifically, lithium oxide (Li₂O) not only serves as a kind of protective film, but also allows the lithium metal and lithium alloy to be uniformly deposited so that reversible charging and discharging may occur.

Thereby, the protective layer 20 may include lithium metal, lithium oxide, and two types of lithium alloys during charging.

When the all-solid-state battery is discharged, opposite reactions of Scheme 1, Scheme 2, and Scheme 3 occur, enabling reversible charging and discharging.

The metal oxide and the metal may have particle sizes (D₅₀) in a range of 0.1 μm to 1 μm. If the particle sizes (D₅₀) of the metal oxide and the metal are 1 μm or more, the particle sizes of the lithium alloy and lithium oxide formed from the metal oxide and the metal may excessively increase, making it difficult to obtain the aforementioned effect.

The protective layer 20 may further include a binder that imparts adhesion between the metal oxide and the metal. The binder may include any material widely used in the technical field to which the present disclosure belongs, and for example, may include butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC), polyethylene oxide (PEO), or a combination thereof.

The mass ratio of the metal oxide to the metal in the protective layer 20 may be in a range of 3:7 to 7:3. If the mass ratio of the metal oxide to the metal is less than 3:7 and thus the amount of the metal oxide is small, or if the mass ratio thereof exceeds 7:3 and thus the amount of the metal oxide is large, reversible charging and discharging may become difficult due to non-uniform deposition of the lithium alloy because the metal oxide forms an alloy with lithium in a higher voltage range than the metal.

The protective layer 20 does not include a separate carbon material. A conventional anode-less all-solid-state battery uses a carbon material or the like to provide a space in which lithium may be precipitated or deposited. In the present disclosure, however, since lithium ions are precipitated or deposited in the form of a lithium alloy formed by reaction of a metal element derived from the metal oxide and lithium ions, a lithium alloy formed by reaction of the metal and lithium ions, and lithium metal growing therefrom, charging and discharging may be reversibly performed without the need to use a separate carbon material.

The protective layer 20 may have a thickness in a range of 1 to 20 μm. If the thickness of the protective layer 20 is less than 1 μm, the aforementioned effect may not be obtained due to insufficient amount of the metal oxide, whereas if the thickness thereof exceeds 20 μm, reversible charging and discharging may become difficult due to an excessively high thickness.

A lithium ion diffusivity coefficient (D) of the protective layer may be in a range of 1.2 to 2.3 m²/s.

The solid electrolyte layer 30 may be interposed between the cathode layer 40 and the anode current collector 10 to allow lithium ions to move between the two components.

The solid electrolyte layer 30 may include an oxide-based solid electrolyte or a sulfide-based solid electrolyte. Here, a sulfide-based solid electrolyte having high lithium ion conductivity may be used. The sulfide-based solid electrolyte is not particularly limited, and examples thereof may include one or more of Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (in which m and n are positive numbers, and Z is any one selected from among Ge, Zn, and Ga), Li₂S—GeS₂, Li₂S—SiS₂-LisPO₄, Li₂S—SiS₂-LiₓMO_{y} (in which x and y are positive numbers, and M is any one selected from among P, Si, Ge, B, Al, Ga, and In), Li₁₀GeP₂S₁₂, and the like.

The cathode layer 40 may include a cathode active material, a solid electrolyte, a conductive material, a binder, and the like.

The cathode active material may be an oxide active material or a sulfide active material.

Examples of the oxide active material may include a rock-salt-layer-type active material such as one or more of LiCoO₂, LiMnO₂, LiNiO₂, LiVO₂, Li₁₊ₓNi_{1/3}Co_{1/3}Mn_{1/3}O₂, etc., a spinel-type active material such as LiMn₂O₄, Li(Ni_{0.5}Mn_{1.5}) O₄, etc., an inverse-spinel-type active material such as LiNiVO₄, LiCoVO₄, etc., an olivine-type active material such as LiFePO₄, LiMnPO₄, LiCoPO₄, LiNiPO₄, etc., a silicon-containing active material such as Li₂FeSiO₄, Li₂MnSiO₄, etc., a rock-salt-layer-type active material in which a portion of a transition metal is substituted with a different metal, such as LiNi_{0.8}Co_{(0.2-x)}AlₓO₂ (0<x<0.2), a spinel-type active material in which a portion of a transition metal is substituted with a different metal, such as Li₁₊ₓMn_{2-x-y}M_{y}O₄ (in which M is at least one selected from among Al, Mg, Co, Fe, Ni and Zn, 0<x+y<2), lithium titanate such as Li₄Ti₅O₁₂, and the like.

Examples of the sulfide active material may include one or more of copper Chevrel, iron sulfide, cobalt sulfide, nickel sulfide, and the like.

The solid electrolyte may be an oxide solid electrolyte or a sulfide solid electrolyte. Here, a sulfide-based solid electrolyte having high lithium ion conductivity may be used. The sulfide-based solid electrolyte is not particularly limited, and examples thereof may include one or more of Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (in which m and n are positive numbers, and Z is any one selected from among Ge, Zn, and Ga), Li₂S—GeS₂, Li₂S—SiS₂—Li₃PO₄, Li₂S—SiS₂-LiₓMO_{y} (in which x and y are positive numbers, and M is any one selected from among P, Si, Ge, B, Al, Ga, and In), Li₁₀GeP₂S₁₂, and the like.

Examples of the conductive material may include one or more of carbon black, conductive graphite, ethylene black, graphene, and the like.

Examples of the binder may include one or more of butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC), polyethylene oxide (PEO), and the like.

The cathode current collector 50 may be a plate-shaped substrate having electrical conductivity. The cathode current collector 22 may include an aluminum foil.

A method of manufacturing the all-solid-state battery may include preparing a slurry by mixing a metal oxide, a metal, a conductive material, and a binder, forming a protective layer by applying the slurry onto an anode current collector, forming a solid electrolyte layer on the protective layer, forming a cathode layer on the solid electrolyte layer, and forming a cathode current collector on the cathode layer.

Here, the metal oxide, metal, conductive material, and binder are as described above, and thus a detailed description thereof is omitted.

The slurry may be prepared by adding the metal oxide and the like to a solvent and performing mixing. The solvent is not particularly limited, and any solvent capable of dispersing the metal oxide and the like may be used. For example, the solvent may include N-methyl pyrrolidone (NMP), water, ethanol, isopropanol, or a combination thereof.

The slurry may have a solid content in a range of 1 wt. % to 20 wt. %. When the solid content thereof falls within the above range, the protective layer may be more easily formed.

The solid electrolyte layer may be formed using a slurry including a solid electrolyte or by pressing a solid electrolyte in a powder form. Also, the cathode layer may be formed using a slurry including a cathode active material or by pressing a cathode active material in a powder form.

Forming the protective layer, forming the solid electrolyte layer, and forming the cathode layer are not mentioned in chronological order, and individual components may be formed at the same time or at different times. The method may include not only directly forming a solid electrolyte layer on the protective layer and a cathode layer on the solid electrolyte layer, but also manufacturing individual components separately and then stacking the same in the structure shown in FIG. 1.

The metal and the metal oxide in the method of manufacturing the all-solid-state battery may include contents substantially overlapping with those of the all-solid-state battery described above, and thus a redundant description thereof is omitted.

A better understanding of the present disclosure may be obtained through the following examples. However, these examples are merely set forth to illustrate the present disclosure and are not to be construed as limiting the scope of the present disclosure.

### Example 1

Stainless steel (SUS) was used as an anode current collector, a slurry was prepared by adding zinc oxide (ZnO) as a metal oxide, silver (Ag) as a metal, and PVDF as a binder to NMP as a solvent, and the slurry was applied onto the anode current collector to form a protective layer. A half-cell was manufactured by sequentially stacking lithium metal, a solid electrolyte layer, and the anode current collector with the protective layer formed thereon.

### Example 2

The slurry prepared in the same manner as in Example 1 was applied onto stainless steel to form a protective layer, and a cathode was formed using NCM 711 (loading: 25 mg/cm²). A full cell was manufactured by sequentially stacking the cathode, a solid electrolyte layer, and the anode current collector with the protective layer formed thereon.

### Comparative Example 1

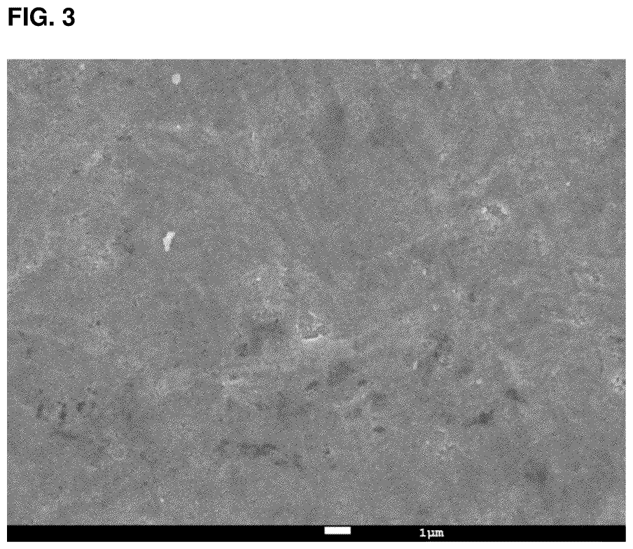

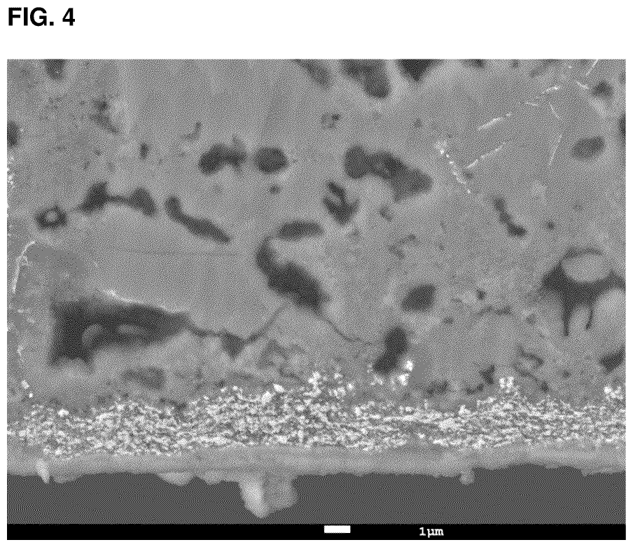

A half-cell was manufactured in the same manner as in Example 1, with the exception that a slurry was prepared by adding only zinc oxide (ZnO), which is a metal oxide, to NMP as a solvent. A top view of the protective layer is shown in FIG. 3, and a cross-sectional view of the manufactured half-cell is shown in FIG. 4.

### Comparative Example 2

A half-cell was manufactured in the same manner as in Example 1, with the exception that a slurry was prepared by adding only silver (Ag), which is a metal, to NMP as a solvent.

### Comparative Example 3

A full cell was manufactured in the same manner as in Example 2 using the slurry of Comparative Example 1.

### Comparative Example 4

A full cell was manufactured in the same manner as in Example 2 using the slurry of Comparative Example 2.

### Test Example 1

The half-cell according to Example 1 was charged and discharged at about 25° C. under conditions of a current density of 1 mA/cm² and a deposition capacity of 3.5 mAh/cm².

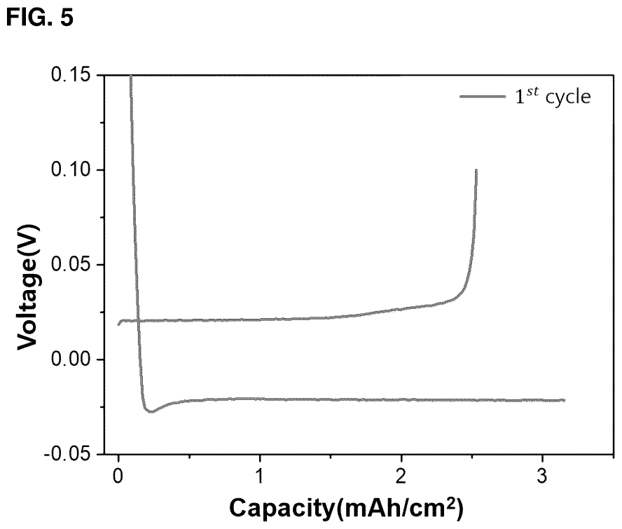

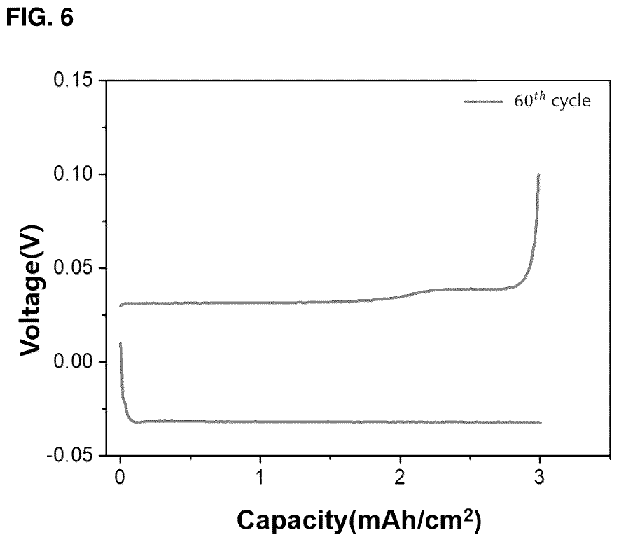

FIG. 5 shows a 1^{st} charge/discharge graph of the half-cell according to Example 1, and FIG. 6 shows a 60^{th} charge/discharge graph of the half-cell according to Example 1. With reference to FIGS. 5 and 6, zinc oxide (ZnO) and silver (Ag) electrochemically reacted with lithium ions (Lit) in the half cell, and the half-cell operated stably.

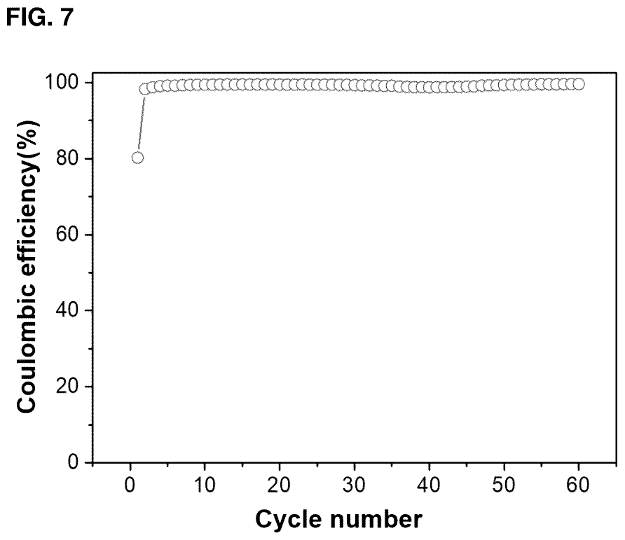

FIG. 7 shows results of evaluating the lifespan of the half-cell according to Example 1. The half-cell had initial efficiency of 80% and average Coulombic efficiency (%) of about 99% or more during 60 cycles.

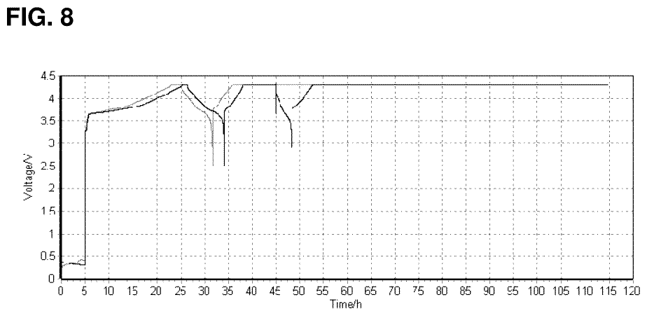

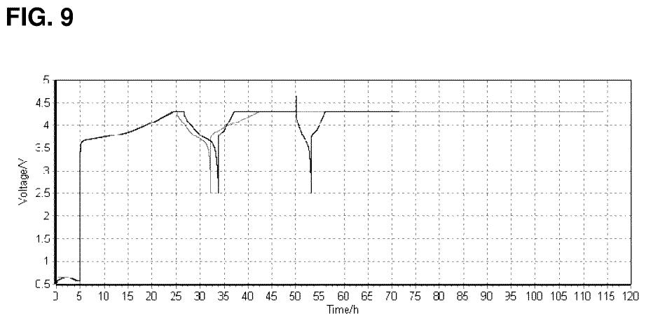

FIG. 8 shows operation of the half-cell according to Comparative Example 1, and FIG. 9 shows operation of the half-cell according to Comparative Example 2. With reference to FIGS. 8 and 9, when the protective layer 20 included only zinc oxide (ZnO) or only silver (Ag), the cell did not operate normally.

### Test Example 2

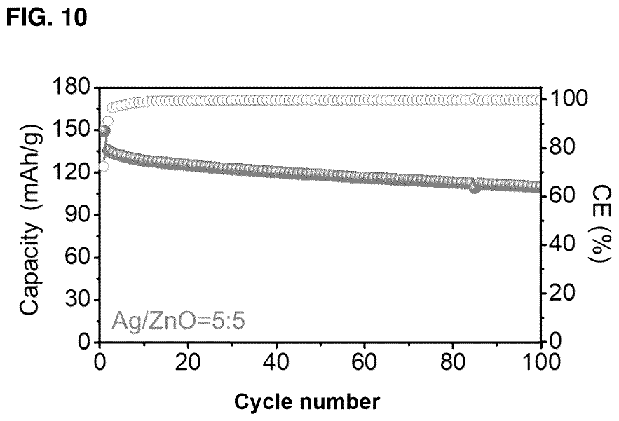

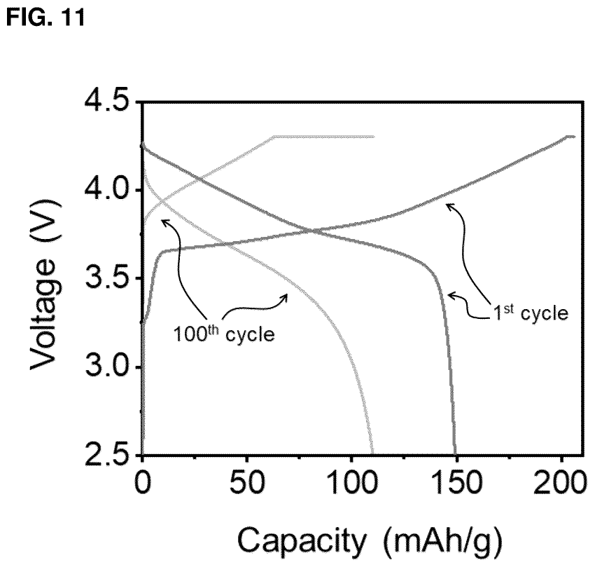

FIG. 10 is a graph showing results of evaluating the lifespan of the full cell according to Example 2, and FIG. 11 shows 1^{st} and 100^{th} discharge graphs of the full cell according to Example 2. The full cell was charged and discharged at about 25° C. under 0.2 C (C-rate) conditions. With reference to FIGS. 10 and 11, the capacity of the first cycle of the full cell was 150 mAh/g, and the capacity retention after 50 cycles compared to the first cycle was 79.4% and the capacity retention after 100 cycles was 73.5%.

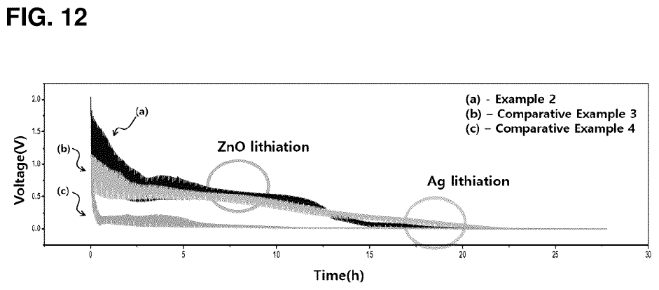

FIG. 12 is a graph showing alloying of a metal oxide and a metal with lithium in different voltage ranges. With reference thereto, zinc oxide (ZnO) formed an alloy with lithium at 0.4 V to 0.7 V, and silver (Ag) formed an alloy with lithium at 0.1 V to 0.3 V, confirming reaction with lithium in different voltage ranges.

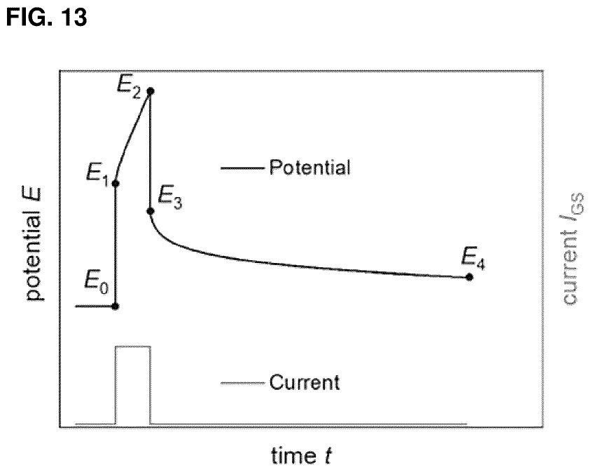

In addition, FIG. 13 schematically shows a half-cell potential graph during a GITT (galvanostatic intermittent titration technique) pulse (A. Nickol et al. Electrochemical Society, 167 (9), 090546 (2020)). In FIG. 13, the lower graph shows a current pulse applied for a short time, and the upper graph shows a time-voltage profile corresponding to the current pulse. Depending on the voltage rise (E₀→E₁→E₂) corresponding to the current pulse and the IR drop (E₂→E₃→E₄) of voltage at the rest stage, the lithium ion diffusivity coefficient (D) may be calculated using Equation 1 below, and the results of calculating the lithium ion diffusivity coefficient from FIG. 12 are shown in Table 1 below.

$${\begin{matrix}D = \frac{4}{9 π} \cdot {( \frac{{E}_{4} - {E}_{0}}{{E}_{3} - {E}_{0}} )}^{2} \cdot \frac{{r}_{P}^{2}}{{t}_{P}} & ∝ ( \frac{{E}_{4} - {E}_{0}}{{E}_{3} - {E}_{0}} )\end{matrix}}^{2} \qquad ( Equation 1 )$$

Here, r_{P} represents the average particle size of the active material in the reference electrode (pristine), and t_{P} represents the pulse duration.

TABLE 1

| | | Comparative | Comparative |
|---|---|---|---|
| | Example 2 | Example 3 | Example 4 |
| Reference electrode (2^{nd} | 0.209842 | 0.05684 | 0.040717 |
| pulse) | | | |
| Zinc oxide lithiation region | 0.022919 | 0.020467 | — |
| Silver lithiation region | 1.474478 | — | 1.128904 |

With reference to FIG. 12 and Table 1, the D value of Example 2 was higher than that of Comparative Examples 3 and 4, and zinc oxide (ZnO) and silver (Ag) were sequentially lithiated.

Moreover, among Example 2, Comparative Example 3, and Comparative Example 4 before lithiation, the D value of Example 2 was the greatest, and the D value of Example 2 was greater than the D value of Comparative Example 3 or Comparative Example 4 in the zinc oxide (ZnO) lithiation region and the silver (Ag) lithiation region, confirming that lithium ion diffusivity was high when using the composite material compared to when using the single material. Specifically, when a cell including an electrode formed of a composite material including both zinc oxide and silver is used, it is easy to diffuse lithium ions while solving a problem in that a cell including an electrode formed of a single material including either zinc oxide or silver cannot operate.

Therefore, when the electrode formed of the composite material is used, uniform lithium deposition may be induced in different voltage ranges, and loads of zinc oxide (ZnO) and silver (Ag) may be dispersed or relieved, enabling more stable lithium deposition.

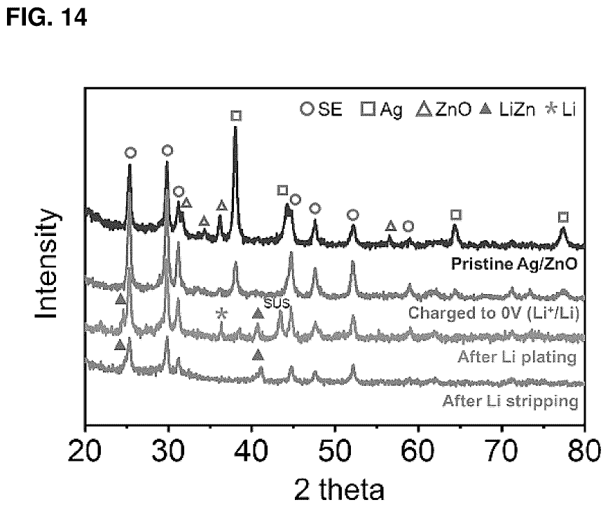

FIG. 14 shows results of analyzing the XRD pattern of the full cell according to Example 2. With reference thereto, a LiZn alloy and Li were formed when lithium was deposited on the protective layer. Moreover, it was possible to perform reversible charging and discharging.

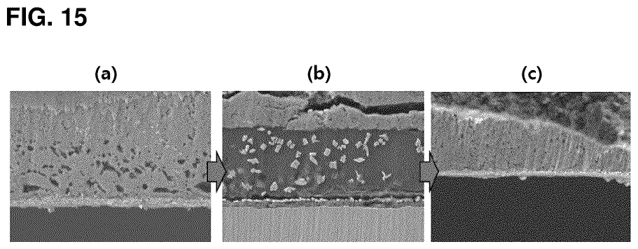

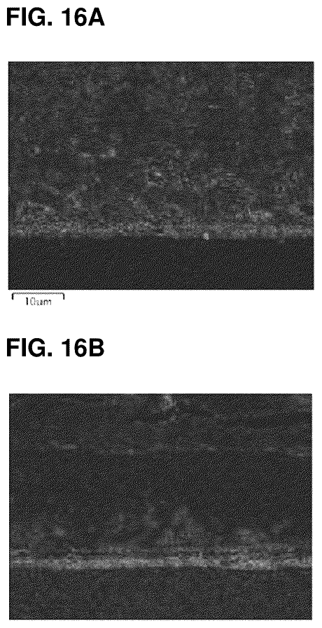

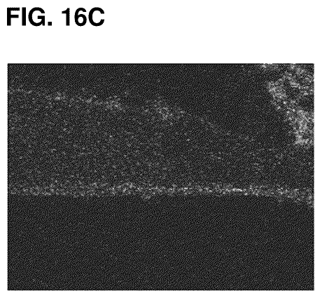

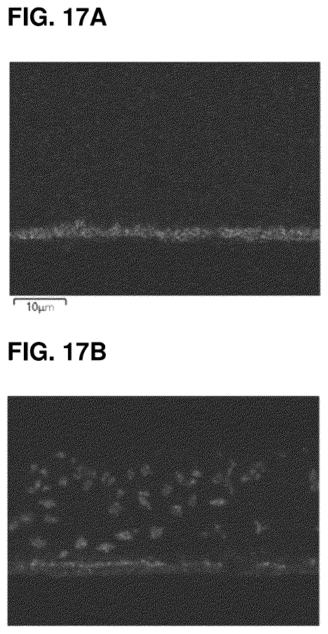

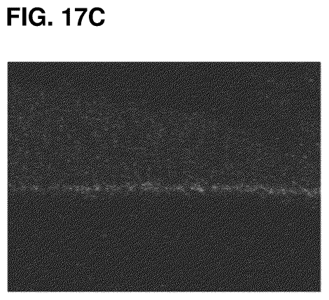

FIG. 15 shows SEM images of the full cell according to Example 2 before charging (a), after charging (b), and upon discharging (c) with time during charging and discharging, FIGS. 16A to 16C show oxygen (O) distribution, and FIGS. 17A to 17C show zinc (Zn) distribution.

With reference to FIGS. 15, 16A to 16C, and 17A to 17C, oxygen (O) and zinc (Zn) were distributed over a wide region in the protective layer in the reference electrode before charging, and lithium was uniformly deposited in the protective layer and at the interface between the anode current collector 10 and the protective layer 20 during charging. Upon discharging, oxygen (O) and zinc (Zn) returned to the same distribution as before charging, confirming that the all-solid-state battery can be reversibly charged and discharged while minimizing dead lithium.

As is apparent from the above description, an all-solid-state battery enables lithium to be uniformly deposited on a protective layer through a metal oxide and a metal, and stable operation thereof is possible even at room temperature (e.g., 20-25° C.), so that clamping pressure applied to the all-solid-state battery can be reduced. Therefore, the all-solid-state battery with improved performance and durability can operate at room temperature in an actual EV.

The effects of the present disclosure are not limited to the above-mentioned effects. It should be understood that the effects of the present disclosure include all effects that can be inferred from the description of the present disclosure.

What is claimed is:

1. An all-solid-state battery comprising:
an anode current collector;
a protective layer disposed on the anode current collector;
a solid electrolyte layer disposed on the protective layer;
a cathode layer disposed on the solid electrolyte layer and comprising a cathode active material; and
a cathode current collector disposed on the cathode layer,
wherein the protective layer comprises a metal and a metal oxide, and
wherein the metal and the metal oxide are capable of alloying with lithium.

2. The all-solid-state battery of claim 1, wherein the metal comprises silver (Ag), magnesium (Mg), zinc (Zn), gold (Au), or a combination thereof.

3. The all-solid-state battery of claim 1, wherein the metal oxide comprises zinc (Zn) oxide, tin (Sn) oxide, silicon (Si) oxide, germanium (Ge) oxide, indium (In) oxide, antimony (Sb) oxide, bismuth (Bi) oxide, gallium (Ga) oxide, aluminum (Al) oxide, titanium (Ti) oxide, zirconium (Zr) oxide, nickel (Ni) oxide, iron (Fe) oxide, cobalt (Co) oxide, chromium (Cr) oxide, magnesium (Mg) oxide, or a combination thereof.

4. The all-solid-state battery of claim 1, wherein a mass ratio of the metal oxide to the metal in the protective layer is in a range of 3:7 to 7:3.

5. The all-solid-state battery of claim 1, wherein the metal oxide is configured to form an alloy with lithium in a higher voltage range than the metal.

6. The all-solid-state battery of claim 1, wherein the metal oxide is configured to form an alloy with lithium at a voltage in a range of 0.4 V to 0.7 V, and wherein the metal is configured to form an alloy with lithium at a voltage in a range of 0.1 V to 0.3 V.

7. The all-solid-state battery of claim 1, wherein the protective layer has a lithium ion diffusivity coefficient (D) in a range of 1.2 m²/s to 2.3 m²/s.

8. The all-solid-state battery of claim 1, wherein the metal oxide and the metal have particle sizes (D₅₀) in a range of 0.1 μm to 1 μm.

9. The all-solid-state battery of claim 1, wherein the protective layer has a thickness in a range of 1 μm to 20 μm.

10. A method of manufacturing an all-solid-state battery, the method comprising:
preparing a slurry by mixing a metal oxide, a metal, a conductive material, and a binder;
forming a protective layer by applying the slurry onto an anode current collector;
forming a solid electrolyte layer on the protective layer;
forming a cathode layer on the solid electrolyte layer; and
forming a cathode current collector on the cathode layer.

11. The method of claim 10, wherein the metal comprises silver (Ag), magnesium (Mg), zinc (Zn), gold (Au), or a combination thereof.

12. The method of claim 10, wherein the metal oxide comprises zinc (Zn) oxide, tin (Sn) oxide, silicon (Si) oxide, germanium (Ge) oxide, indium (In) oxide, antimony (Sb) oxide, bismuth (Bi) oxide, gallium (Ga) oxide, aluminum (Al) oxide, titanium (Ti) oxide, zirconium (Zr) oxide, nickel (Ni) oxide, iron (Fe) oxide, cobalt (Co) oxide, chromium (Cr) oxide, magnesium (Mg) oxide, or a combination thereof.

13. The method of claim 10, wherein a mass ratio of the metal oxide to the metal in the protective layer is in a range of 3:7 to 7:3.

14. The method of claim 10, wherein the protective layer has a lithium ion diffusivity coefficient (D) in a range of 1.2 m²/s to 2.3 m²/s.

15. The method of claim 10, wherein the metal oxide and the metal have particle sizes (D₅₀) in a range of 0.1 μm to 1 μm.

16. The method of claim 10, wherein the protective layer has a thickness in a range of 1 μm to 20 μm.
